(19) United States
(12) Patent Application Publication
(10) Pub. No.: US 2024/0249398 A1
(43) Pub. Date: Jul. 25, 2024

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: HISATO SEKINE, Kanagawa (JP)

(21) Appl. No.: 18/419,069

(22) Filed: Jan. 22, 2024

(30) Foreign Application Priority Data
Jan. 23, 2023 (JP) 2023-008181

(51) Int. Cl. G06T 5/73; G06T 5/92; G06V 10/60

(52) U.S. Cl. CPC G06T 5/73; G06T 5/92; G06V 10/60

(57) ABSTRACT

An image processing apparatus comprises one or more memories and one or more processors. The one or more memories and the one or more processors are configured to calculate an atmospheric transmittance distribution based on an input image, and sharpen the input image based on an illumination distribution that has been calculated based on the transmittance distribution.

### BACKGROUND

### Field of the Disclosure

The present disclosure relates to a technique for sharpening an input image.

### Description of the Related Art

In the field of surveillance cameras and on-board cameras, a decrease in visibility in captured images caused by a haze or the like that is present between the camera and the subject is a problem. This is because contrast of a captured image decreases due to light being scattered by fine particle components when passing through the atmosphere. This phenomenon varies in the degree of scattering depending on the distance to the subject, and thus, a captured image of a scene with varying distances to the subject varies in the degree to which contrast decreases for each image region. As techniques for correcting such a decrease in contrast, there are techniques such as that of U.S. Pat. No. 8,340,461. In the technique of U.S. Pat. No. 8,340,461, assuming that a haze or the like causes fading of a black color, an atmospheric transmittance distribution is calculated from regionally minimum color channel values (hereinafter, referred to as dark channels) and the effect of the haze is removed (hereinafter, referred to as dehazing) based on an atmospheric model. Further, in a method of Xinggang Liu, Sichuan University, “Dehaze Enhancement Algorithm Based on Retinex Theory for Aerial Images Combined with Dark Channel” and Access Library Journal, 2020, Volume 7, visibility is improved by performing dark portion correction and bright portion correction based on a Retinex theory, in addition to dehazing in which dark channels are used.

However, in the method of U.S. Pat. No. 8,340,461, there are problems, such as crushed shadows and blown highlights, after dehazing. Meanwhile, in the method of Xinggang Liu, Sichuan University, “Dehaze Enhancement Algorithm Based on Retinex Theory for Aerial Images Combined with Dark Channel” and Access Library Journal, 2020, Volume 7, an illumination distribution to be used in the Retinex theory is further calculated after a transmittance distribution to be used in dehazing is calculated, and thus, the processing cost increases.

### SUMMARY

Embodiments of the present disclosure provide a technique that allows execution of image sharpening processing at a smaller processing cost than that of conventional techniques.

According to the first aspect of the present disclosure, there is provided an image processing apparatus comprising one or more memories and one or more processors. The one or more memories and the one or more processors are configured to calculate an atmospheric transmittance distribution based on an input image and sharpen the input image based on an illumination distribution that has been calculated based on the transmittance distribution.

According to the second aspect of the present disclosure, there is provided an image processing method performed by an image processing apparatus, the method comprising calculating an atmospheric transmittance distribution based on an input image and sharpening the input image based on an illumination distribution that has been calculated based on the transmittance distribution.

According to the third aspect of the present disclosure, there is provided a non-transitory computer-readable storage medium storing a computer program for causing a computer to calculate an atmospheric transmittance distribution based on an input image and sharpen the input image based on an illumination distribution that has been calculated based on the transmittance distribution.

Further features of various embodiments will become apparent from the following description of exemplary embodiments with reference to the attached drawings.

### BRIEF DESCRIPTION OF THE DRAWINGS

FIG. 1 is a diagram illustrating an example of a configuration of a system.

FIG. 2 is a block diagram illustrating an example of a hardware configuration that is applicable to a camera 100.

FIG. 3 is a block diagram illustrating an example of a functional configuration of an image processing unit 208.

FIG. 4 is a flowchart of a process to be performed by the camera 100.

FIG. 5A is a diagram illustrating a process for generating a dark channel image from a developed image J′.

FIG. 5B is a diagram illustrating a process for generating a dark channel image from the developed image J′.

FIG. 5C is a diagram illustrating a process for generating a dark channel image from the developed image J′.

FIG. 5D is a diagram illustrating a process for generating a dark channel image from the developed image J′.

FIG. 6 is a diagram illustrating transmittance distribution shaping processing.

FIG. 7 is a block diagram illustrating an example of a functional configuration of a processing unit 306.

FIG. 8 is a flowchart for explaining details of a process in step S408.

FIG. 9 is a diagram for explaining a relationship between haze density and contrast.

FIG. 10 is a diagram for explaining haze density calculation.

FIG. 11 is a diagram for explaining a dark portion correction and bright portion correction gain value.

FIG. 12 is a diagram for explaining a maximum value of a gain to be applied.

FIG. 13 is a diagram for explaining dark portion correction and bright portion correction based on a Retinex theory.

FIG. 14 is a block diagram illustrating an example of a functional configuration of the image processing unit 208.

FIG. 15 is a flowchart of a process to be performed by the camera 100.

FIG. 16 is a diagram illustrating an example of display of a GUI 1601.

FIG. 17 is a block diagram illustrating an example of a functional configuration of a processing unit 1406.

FIG. 18 is a diagram illustrating an example of a configuration of a system.

FIG. 19 is a block diagram illustrating an example of a functional configuration of an image processing unit 1857.

FIG. 20 is a flowchart of a process to be performed by a computer apparatus 1800.

### DESCRIPTION OF THE EMBODIMENTS

Hereinafter, embodiments will be described in detail with reference to the attached drawings. Note, the following embodiments are not intended to limit the scope of every embodiment. Multiple features are described in the embodiments, but limitation is not made to embodiments that require all such features, and multiple such features may be combined as appropriate. Furthermore, in the attached drawings, the same reference numerals are given to the same or similar configurations, and redundant description thereof is omitted.

### First Embodiment

In the present embodiment, an example of an image processing apparatus that calculates an atmospheric transmittance distribution based on an input image and, based on an illumination distribution that has been calculated based on that transmittance distribution, sharpens that input image will be described.

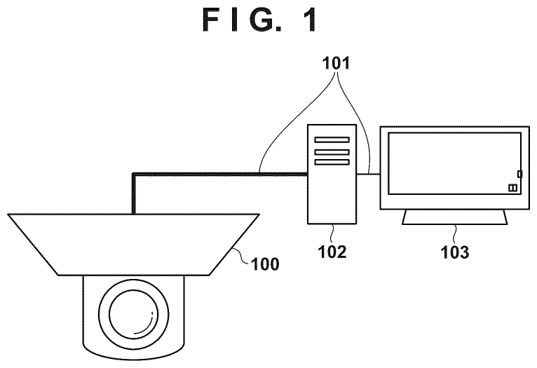

First, an example of a configuration of a system according to the present embodiment will be described with reference to FIG. 1. As illustrated in FIG. 1, the system according to the present embodiment includes a camera 100, which serves as an image processing apparatus; a computer apparatus 102; and a display 103. The camera 100 and the computer apparatus 102 and the display 103 are connected to each other via a video transmission cable 101, such as an HDMI or serial digital interface (SDI) cable, so as to be capable of communication. The method of connection between the camera 100 and the computer apparatus 102 and between the computer apparatus 102 and the display 103 is not limited to a particular method of connection, and the apparatuses may be connected by, for example, a wire or wireless LAN.

First, the camera 100 will be described. The camera 100 is an example of an image capturing apparatus that is capable of autonomously controlling its pan, tilt, and zoom in response to an instruction from the computer apparatus 102 and captures a moving image or still images. When capturing a moving image, the camera 100 outputs, as captured images, images for which sharpening processing, which will be described later, has been performed on the image of each frame in the moving image. When capturing still images, the camera 100 outputs, as captured images, images for which sharpening processing, which will be described later, has been performed on still images that have been captured at regular or irregular intervals. The captured images that have been outputted from the camera 100 are inputted to the computer apparatus 102 via the video transmission cable 101. The captured images that have been outputted from the camera 100 may be outputted to the display 103 via a communication path (not illustrated) and displayed on the display 103.

Next, the display 103 will be described. The display 103 includes a liquid crystal screen or a touch panel screen and displays images and text that have been outputted from the computer apparatus 102 or the camera 100. In addition, if the display 103 includes a touch panel screen, the computer apparatus 102 is notified of an operation input that a user has performed on the touch panel screen via a communication channel (not illustrated).

Next, the computer apparatus 102 will be described. The computer apparatus 102 is a computer apparatus, such as a personal computer (PC), a smartphone, or a tablet terminal apparatus. The computer apparatus 102 transmits image capturing instructions to the camera 100 and sets parameters of the camera 100 as well as holds therein or transfers to another apparatus captured images that have been outputted from the camera 100.

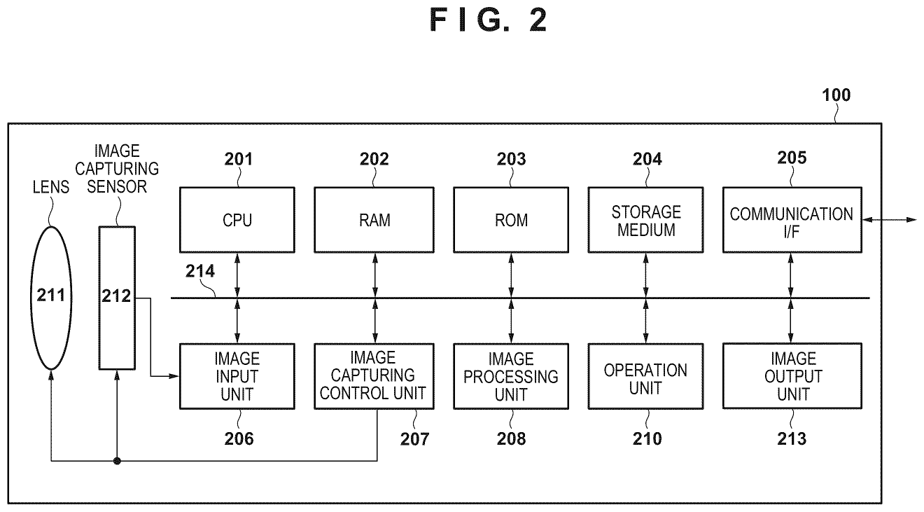

Next, an example of a hardware configuration that is applicable to the above-described camera 100 will be described with reference to a block diagram of FIG. 2. A CPU 201 executes various kinds of processing using computer programs and data that are stored in a RAM 202. The CPU 201 thus controls the operation of the entire camera 100 and executes or controls various kinds of processing, which will be described as processes to be performed by the camera 100.

The RAM 202 includes an area for storing computer programs and data that have been loaded from a ROM 203 or a storage medium 204 and an area for storing computer programs and data that have been received from the computer apparatus 102 via a communication I/F 205. The RAM 202 further includes an area for storing RAW images that an image input unit 206 has obtained from an image capturing sensor 212. The RAM 202 further includes a work area that the CPU 201 and an image processing unit 208 use when executing various kinds of processing. The RAM 202 can thus provide various kinds of areas as appropriate.

The ROM 203 stores setting data of the camera 100, computer programs and data that are related to the startup of the camera 100, computer programs and data related to basic operations of the camera 100, and the like.

The storage medium 204 is a memory device, such as an SSD, an SD card, or a USB memory, and can store results of processing by the camera 100 and computer programs and data that have been received from the computer apparatus 102 via the communication I/F 205. The computer programs and data that are stored in the storage medium 204 are loaded into the RAM 202 as appropriate according to control by the CPU 201 and are set to be processed by the CPU 201.

The communication I/F 205 is an interface, such as HDMI or SDI, and is an interface for performing data communication with the computer apparatus 102 and the display 103 via the video transmission cable 101.

External light enters the image capturing sensor 212 via a lens 211. The image capturing sensor 212 generates a RAW image by photoelectrically converting the light that has entered and outputs the generated RAW image. The image input unit 206 obtains the RAW image that has been output from the image capturing sensor 212. An image capturing control unit 207 controls the driving of the lens 211 and the operation of the image capturing sensor 212 under the control of the CPU 201.

The image processing unit 208 is a hardware circuit that performs, under the control of the CPU 201, various kinds of processing for generating, as a sharpened image, an image on which dehazing processing and bright portion and dark portion correction processing have been performed based on a RAW image that has been obtained by the image input unit 206.

An operation unit 210 is a user interface, such as a button, a switch, and a touch panel, and by operating it, the user can input various kinds of instructions to the CPU 201. An image output unit 213 outputs a sharpened image that has been generated by the image processing unit 208 to the computer apparatus 102 or the display 103 via the communication I/F 205.

The CPU 201, the RAM 202, the ROM 203, the storage medium 204, the communication I/F 205, the image input unit 206, the image capturing control unit 207, the image processing unit 208, the operation unit 210, and the image output unit 213 are all connected to a system bus 214.

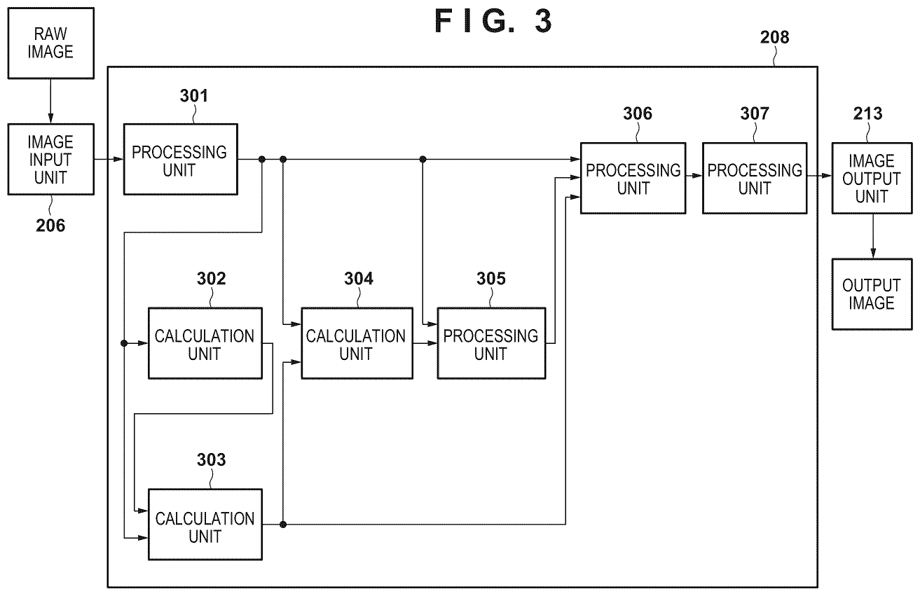

Next, an example of a functional configuration of the image processing unit 208 is illustrated in a block diagram of FIG. 3. All of the functional units that are illustrated in FIG. 3 will be described below as being implemented by hardware. However, one or more of the functional units that are illustrated in FIG. 3 may be implemented by software (computer programs), and in such cases, the functions of the one or more functional units are realized by the CPU 201 executing the computer programs that correspond to the one or more functional units.

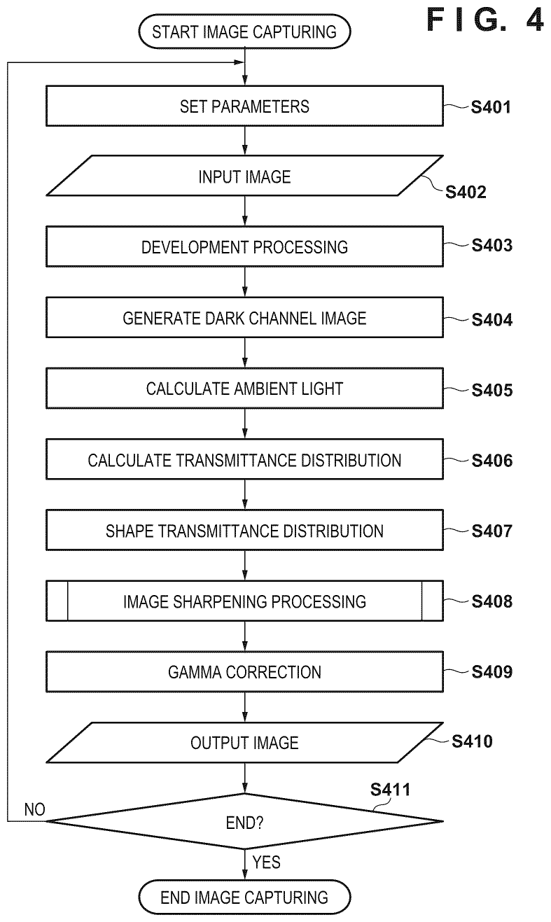

A process to be performed by the camera 100 to generate a sharpened image based on a RAW image that the image input unit 206 has obtained from the image capturing sensor 212 will be described with reference to a flowchart of FIG. 4.

In step S401, the CPU 201 loads into the RAM 202 and sets “various parameters to be used in the subsequent processes”, which are stored in the ROM 203 or the storage medium 204.

Upon receiving light that has entered through the lens 211, which has been controlled to be driven by the image capturing control unit 207, the image capturing sensor 212 generates a RAW image based on the received light and outputs the generated RAW image, under control of the image capturing control unit 207. Here, in step S402, the image input unit 206 obtains a RAW image J, which has been outputted from the image capturing sensor 212, and inputs the obtained RAW image J to the image processing unit 208. Here, J(x, y) represents the pixel value of the pixel of a pixel position (x, y) in the RAW image J. In the RAW image J, R, G, or B colors are arranged in each pixel in a Bayer arrangement.

In step S403, a processing unit 301 generates a developed image (input image) J′ by performing development processing on the RAW image J. Here, J′(x, y, c) represents the pixel value of the color channel c (c=R, G, B) of the pixel of a pixel position (x, y) in the developed image J. The processing unit 301 performs image processing, such as white balancing, Debayering, noise reduction, sharpening, and color conversion, on such a RAW image J.

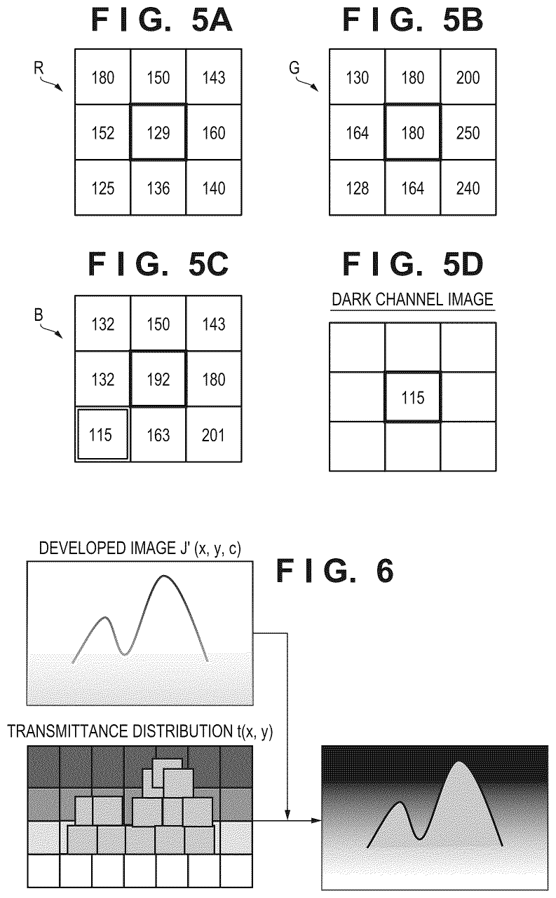

In step S404, a calculation unit 302 generates, from the developed image J′, a dark channel image in which the minimum color channel values of respective local regions in the developed image J′ are set as pixel values. Here, a process for generating a dark channel image from the developed image J′ will be described with reference to FIGS. 5A to 5D. In order to generate a dark channel image from the developed image J′, the calculation unit 302 sets, as a search range, a 3 pixel×3 pixel image region that is centered on a pixel of interest in the developed image J′. FIG. 5A illustrates the red (R) pixel value of each pixel that is included in the search range, FIG. 5B illustrates the green (G) pixel value of each pixel that is included in the search range, and FIG. 5C illustrates the blue (B) pixel value of each pixel that is included in the search range. The calculation unit 302 identifies the smallest pixel value among the R pixel values, the G pixel values, and the B pixel values of respective pixels that are included in the search range and sets the identified pixel value as the pixel value of a pixel that corresponds to the pixel of interest in the dark channel image. In the case of FIGS. 5A to 5D, the smallest pixel value among the R pixel values, the G pixel values, and the B pixel values of respective pixels that are included in the search range is “115”. Accordingly, the calculation unit 302 sets the pixel value “115” as the pixel value of the pixel that corresponds to the pixel of interest in the dark channel image as illustrated in FIG. 5D. By performing the above-described process using each pixel in the developed image J′ as a pixel of interest, the pixel value of each pixel in the dark channel image can be determined.

In step S405, a calculation unit 303 calculates (estimates) an ambient light A(c) of the color channel c using the dark channel image that has been generated in step S404. Ambient light is a light component for which light from the sun, the sky, and the like has been scattered by haze. Here, A(c) is a light component that corresponds to the color channel c. Methods of calculating environmental light from an image are well known, and for example, environmental light can be calculated using the method described in U.S. Pat. No. 8,340,461. Specifically, a region in which the magnitudes of pixel values of the dark channel image are the top 0.1% is extracted, and for that region, the ambient light A(c) is obtained from average RGB of the developed image J′, which has been developed in step S403.

In step S406, a calculation unit 304 calculates an atmospheric transmittance distribution t according to the following Equation 1 using the developed image J′ and the ambient light A(c). Here, t(x, y) represents an atmospheric transmittance that corresponds to a pixel position (x, y) in the developed image J′.

$$t ( x , y ) = 1.0 - ω \cdot D ( \frac{{J}^{′} ( x , y , c )}{A ( c )} ) \qquad ( Equation 1 )$$

Here, D(⋅) is a function for calculating a dark channel image and is a function for generating a dark channel image in step S404. In addition, ω is a real number parameter (parameter for performing control so as to prevent the transmittance of a distant subject does from becoming too large) that is set within a range of 0 to 1 and is set in step S401. Regarding ω, the lower the value, the greater the intensity of control at which the transmittance of a distant subject is prevented from becoming too large, and thus, a correction amount decreases. In the present embodiment, ω=0.95.

In step S407, a processing unit 305 generates a shaped transmittance distribution t′ by performing shaping processing on the transmittance distribution t using the developed image J. Here, t′(x, y) represents an atmospheric transmittance that corresponds to a pixel position (x, y) in the developed image J. Here, transmittance distribution shaping processing will be described with reference to FIG. 6. Regarding the transmittance distribution t, calculation is performed for each rectangular region, and thus, the block shapes of the regions remain. Therefore, in the shaping processing, a shaped transmittance distribution t′ in which the blockiness of the transmittance distribution t is reduced is generated using the developed image J as a guide image. In the shaping processing, the blockiness is reduced using a guided filter; however, a cross bilateral filter or the like may be used, and the shaping processing is not limited to a specific technique.

In step S408, a processing unit 306 generates a sharpened image I by performing sharpening processing on the developed image J using the ambient light A(c) and the shaped transmittance distribution t′. Here, I(x, y, c) represents the pixel value of the color channel c (c=R, G, B) of the pixel of a pixel position (x, y) in the sharpened image I. Details of the process in step S408 will be described later.

In step S409, a processing unit 307 generates an output image (gamma-corrected sharpened image) I′ by performing gamma correction on the sharpened image I, which has been generated in step S408. In step S410, the image output unit 213 outputs the output image I′, which has been generated in step S409, to the computer apparatus 102 via the communication I/F 205.

In step S411, the CPU 201 determines whether a condition for ending the process has been satisfied. Various conditions are applicable to the condition for ending the process. For example, there are “it has been detected that the power of the camera 100 has been turned off”, “the length of time during which the image input unit 206 has not been obtaining a RAW image is a predetermined length of time or more”, “it has been detected that the user has inputted an instruction for ending the process by operating the operation unit 210”, and the like.

If the result of such determination is that the condition for ending the process has been satisfied, the process according to the flowchart of FIG. 4 ends, and if the condition for ending the process has not been satisfied, the process proceeds to step S401.

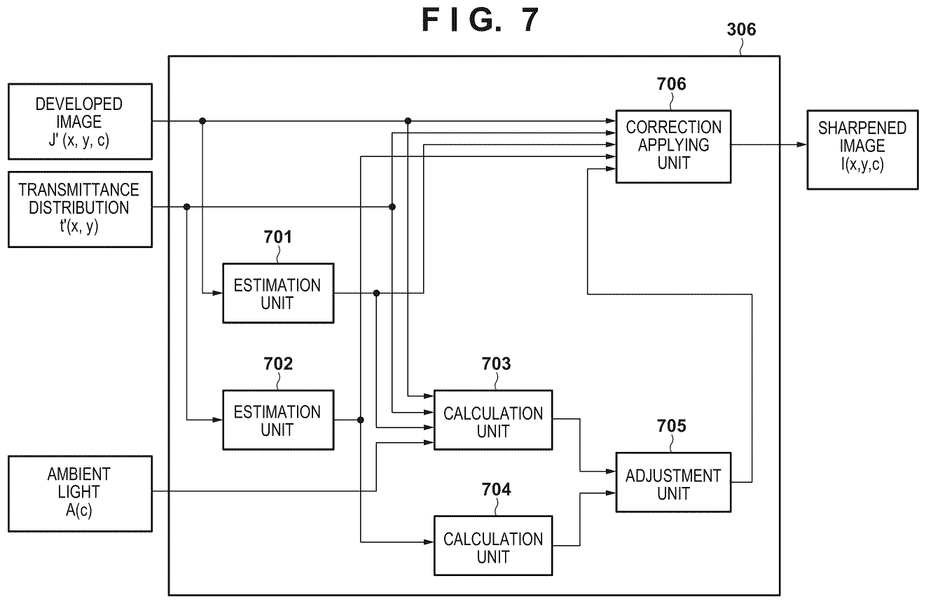

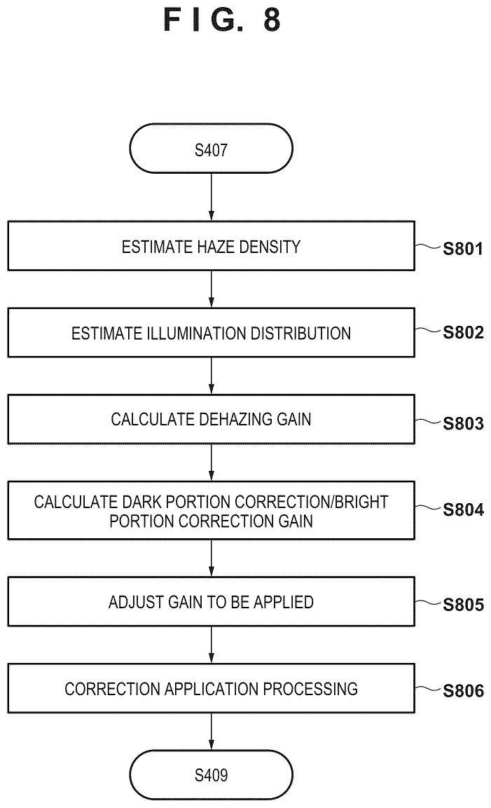

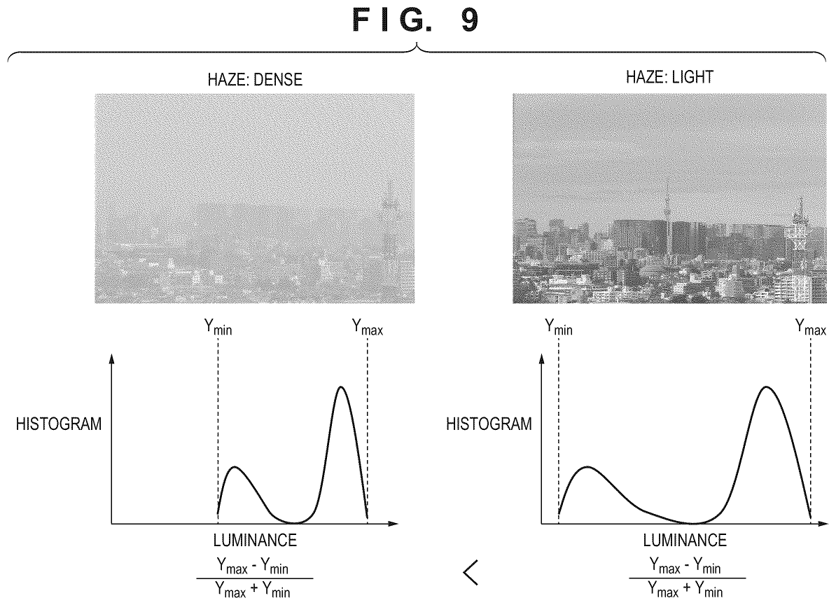

Next, details of the process in the above-described step S408 will be described according to the flowchart of FIG. 8. An example of a functional configuration of the processing unit 306 is illustrated in a block diagram of FIG. 7. In the present embodiment, in the sharpening processing, the processing unit 306 generates a sharpened image for which the visibility of a developed image has been improved by performing dark portion correction and bright portion correction according to a Retinex theory in addition to the dehazing processing.

Here, the Retinex theory will be described. The Retinex theory models human vision and is a method that is used in captured image dynamic range compression and the like. In the Retinex theory, an image II is considered by separating it into a reflected light distribution RR and an illumination light distribution LL as indicated in the following Equation 2.

$$II = LL \cdot RR \qquad ( Equation 2 )$$

At this time, employing the human visual property that it is insensitive to the illumination light distribution LL, only LL is compressed. Here, as in FIG. 13, LL, which is the input, is converted into LL′ such that dark portions are brightened (hereinafter, dark portion correction) and bright portions are darkened (hereinafter, bright portion correction). At this time, the corrected image II′ can be generated according to the following Equation 3.

$$I {I}^{′} = L {L}^{′} \cdot RR \qquad ( Equation 3 )$$

Equation 3 can be expressed as indicated in the following Equation 4 using Equation 2.

$$I {I}^{′} = II \cdot {LL}^{′} / LL \qquad ( Equation 4 )$$

The above is a correction method in which the Retinex theory is used.

In step S801, an estimation unit 701 estimates a density (haze density) s of a haze based on the developed image J. As illustrated in FIG. 9, regarding the contrast of an image of a hazy scene, generally, the higher the density of the haze, the lower the contrast, and the lower the density of the haze, the higher the contrast. Therefore, the estimation unit 701 identifies a maximum value Ymax and a minimum value Ymin of the brightness values in the developed image J and obtains a contrast C of the developed image J according to the following Equation 5, using the identified maximum value Ymax and minimum value Ymin of the brightness values.

$$C = ( Y max - Y min ) / ( Y max + Y min ) \qquad ( Equation 5 )$$

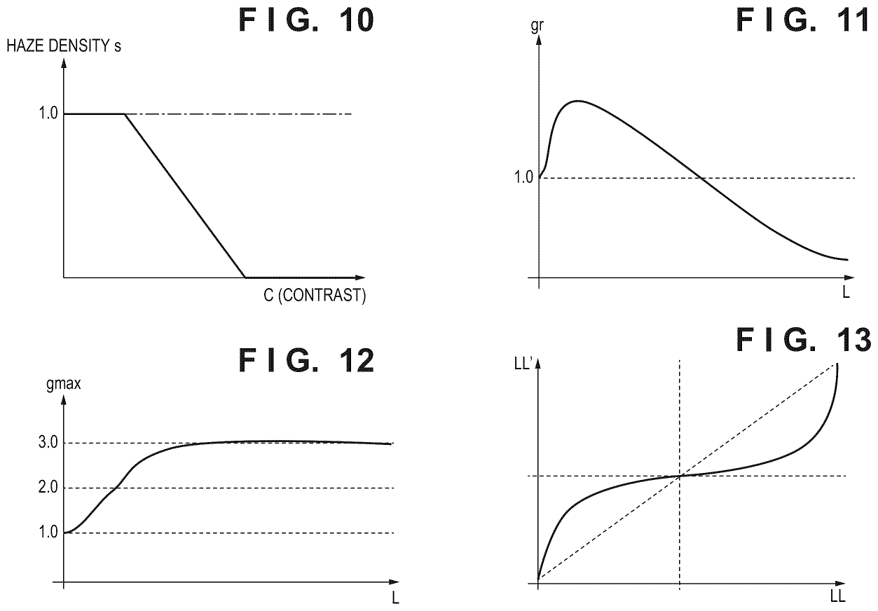

Next, the estimation unit 701 identifies (estimates) the haze density s that corresponds to the contrast C, which has been obtained according to Equation 5, using a “correspondence relationship between the contrast C and the haze density s” that is illustrated in FIG. 10. The correspondence relationship illustrated in FIG. 10 is an example of the correspondence relationship between the contrast C and the haze density s in which “the lower the contrast C, the higher the haze density s, and the higher the contrast C, the lower the haze density s”. The correspondence relationship of FIG. 10 may be implemented as a look-up table or as a function.

In step S802, an estimation unit 702 obtains an illumination distribution L using the shaped transmittance distribution t′. Here, L(x, y) represents an intensity of illumination light that corresponds to a pixel position (x, y) in the developed image J′. Regarding the values of a subject-illuminating illumination distribution, generally, the tendency is that the stronger the illumination, the greater the values of the distribution in the dark portions, and the weaker the illumination, the smaller the values of the distribution in the dark portions. Accordingly, the estimation unit 702 calculates the illumination distribution L by inverting the shaped transmittance distribution t′, which has been calculated from the amount of fading of a black color caused by the haze, as indicated in the following Equation 6.

$$L ( x , y ) = 1. - α \cdot {t}^{′} ( x , y ) \qquad ( Equation 6 )$$

Here, a is a parameter for adjusting the illumination distribution and is a parameter that assumes a real value from 0 to 1.0. It can be assumed that the illumination distribution L approaches uniformity as a approaches 0.

In step S803, a calculation unit 703 obtains a maximum gain gd to be applied in the dehazing processing using the developed image J′, the ambient light A(c), the haze density s, and the shaped transmittance distribution t′ as indicated in the following Equation 7.

$${g}_{d} ( x , y ) = s \cdot {max}_{c} \vert \frac{{J}^{′} ( x , y , c ) - A ( c )}{min ( {t}_{min} , {t}^{′} ( x , y ) )} \vert \qquad ( Equation 7 )$$

Here, gd(x, y) represents a maximum gain that corresponds to a pixel position (x, y) in the developed image J′. Further, tₘᵢₙ is a factor for preventing zero division, and in the present embodiment, tₘᵢₙ=0.01. Here, by using the haze density s, it is possible to adjust the maximum gain applied in dehazing.

In step S804, a calculation unit 704 identifies a dark portion correction/bright portion correction gain gr, which corresponds to the illumination distribution L, which has been obtained in step S802, using a “correspondence relationship between the illumination distribution L and the dark portion correction/bright portion correction gain gr” that is illustrated in FIG. 11. Here, gd(x, y) represents a dark portion correction/bright portion correction gain that corresponds to the pixel position (x, y) in the developed image J′. Further, the correspondence relationship that is illustrated in FIG. 11 is only an example. The correspondence relationship of FIG. 11 may be implemented as a look-up table or as a function.

In step S805, an adjustment unit 705 obtains a gain-to-be-applied gr′, which is to be applied in dark portion correction and bright portion correction, using the illumination distribution L, the maximum gain gd, and the dark portion correction/bright portion correction gain gr.

Dehazing and dark portion correction/bright portion correction are digital gains. Thus, application results in amplification of noise. In this process, a decrease in visibility that is caused by noise amplification is reduced by controlling the amount of amplified noise. The adjustment unit 705 obtains a combined gain gₜₒₜₐₗ to be applied by dehazing and dark portion correction/bright portion correction according to the following Equation 8.

$${g}_{total} ( x , y ) = gd ( x , y ) * gr ( x , y ) \qquad ( Equation 8 )$$

Further, the adjustment unit 705 identifies a gain gₘₐₓ, which corresponds to the illumination distribution L, using a “correspondence relationship between the illumination distribution L and the gain gₘₐₓ” that is illustrated in FIG. 12. The correspondence relationship that is illustrated in FIG. 12 is only an example. The correspondence relationship of FIG. 12 may be implemented as a look-up table or as a function. Then, the adjustment unit 705 obtains the gain-to-be-applied gr′, which is to be applied in the dark portion correction and the bright portion correction, according to the following Equation 9.

$$\{ \begin{matrix}{g}_{r}^{′} ( x , y ) = {g}_{r} ( x , y ) ( {g}_{t o t a l} ( x , y ) \leq {g}_{max} ( L ( x , y ) ) ) \\ {g}_{r}^{′} ( x , y ) = \frac{{g}_{max} ( L ( x , y ) )}{{g}_{r}} ( {g}_{t o t a l} ( x , y ) > {g}_{max} ( L ( x , y ) ) )\end{matrix} \qquad ( Equation 9 )$$

Here, gₘₐₓ(L (x, y)) represents a gain gₘₐₓ that corresponds to L(x, y). Here, gr′(x, y) represents a gain to be applied that corresponds to a pixel position (x, y) in the developed image J.

In step S806, a correction applying unit 706 generate the sharpened image I by performing sharpening processing of the developed image J′ using the developed image J′, the shaped transmittance distribution t′, the haze density s, the gain-to-be-applied gr′, and the ambient light A(c), according to the following Equation 10.

$$1 ( x , y , c ) = {g}_{r}^{′} ( x , y ) \cdot ( ( 1 - s ) \cdot {J}^{′} ( x , y , c ) + s ( \frac{{J}^{′} ( x , y , c ) - A ( c )}{min ( {t}_{min} , {t}^{′} ( x , y ) )} + A ( c ) ) ) \qquad ( Equation 10 )$$

As described above, in the present embodiment, crushed shadows and blown highlights that are caused by dehazing processing can be reduced using a dark portion correction/bright portion correction illumination distribution obtained by a simple calculation method of inverting the shaped transmittance distribution t′. In addition, noise amplification is suppressed by suppressing the gain to be applied. Further, the application amount of dehazing processing can be adjusted according to the haze density.

### Second Embodiment

In the following embodiments, which include the present embodiment, assume that differences from the first embodiment will be described and the rest is similar to the first embodiment unless otherwise mentioned below. In the first embodiment, an estimated haze density is used as the application amount of dehazing processing; however, the present embodiment, a value that has been set according to a user operation will be used as the application amount of dehazing processing.

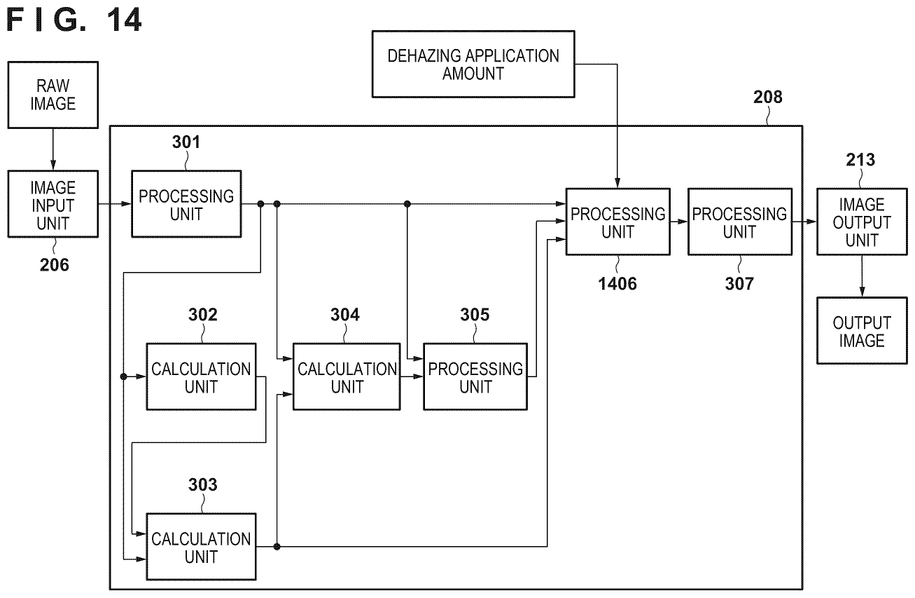

An example of a functional configuration of the image processing unit 208 according to the present embodiment is illustrated in a block diagram of FIG. 14. In FIG. 14, the functional units that are the same as the functional units that are illustrated in FIG. 3 are assigned the same reference numerals, and description pertaining to those functional units will be omitted. All of the functional units that are illustrated in FIG. 14 will be described below as being implemented by hardware. However, one or more of the functional units that are illustrated in FIG. 14 may be implemented by software (computer programs), and in such cases, the functions of the one or more functional units are realized by the CPU 201 executing the computer programs that correspond to the one or more functional units.

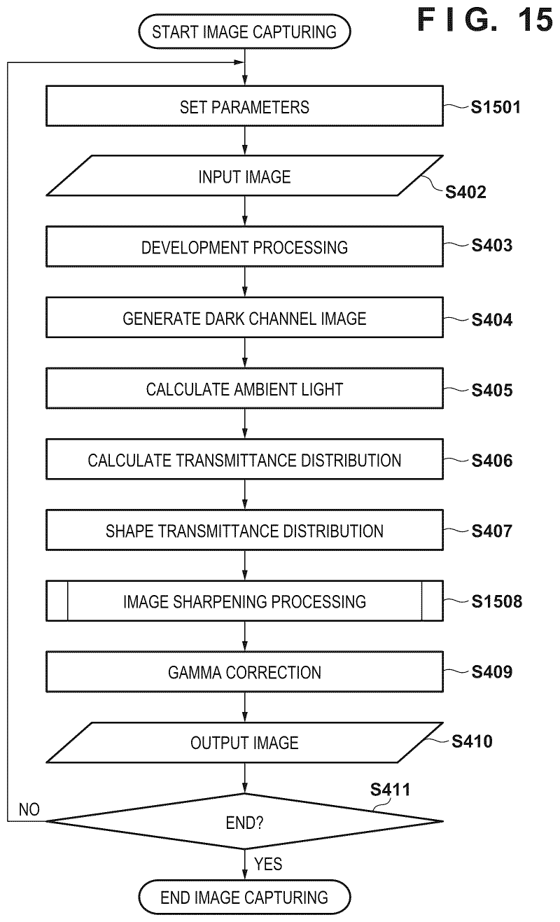

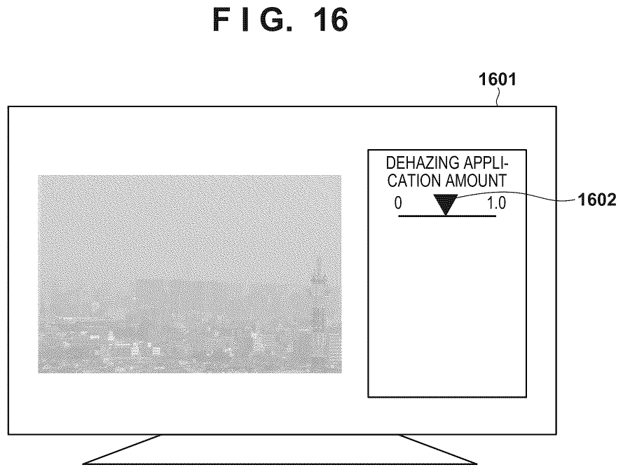

A process to be performed by the camera 100 to generate a sharpened image based on a RAW image that the image input unit 206 has obtained from the image capturing sensor 212 will be described with reference to a flowchart of FIG. 15. In FIG. 15, the processing steps that are the same as the processing steps that are illustrated in FIG. 4 are assigned the same step numerals, and description pertaining to those processing steps will be omitted.

In step S1501, in addition to the process of step S401 described above, the CPU 201 receives an “application amount of dehazing processing (dehazing application amount)”, which is transmitted from the computer apparatus 102 via the communication I/F 205.

For example, if a GUI 1601, which is illustrated in FIG. 16, is displayed on the display screen of the computer apparatus 102, the user can increase or decrease the dehazing application amount by moving an instruction portion 1602 to the left or right by operating a user interface, such as a keyboard or a mouse. The user can specify a dehazing application amount that is closer to 0 by moving the instruction portion 1602 to the left by operating the user interface and can specify a dehazing application amount that is closer to 1 by moving the instruction portion 1602 to the right by operating the user interface. When the user inputs a decision instruction by operating the user interface, the computer apparatus 102 transmits the dehazing application amount that corresponds to the current position of the instruction portion 1602 to the camera 100.

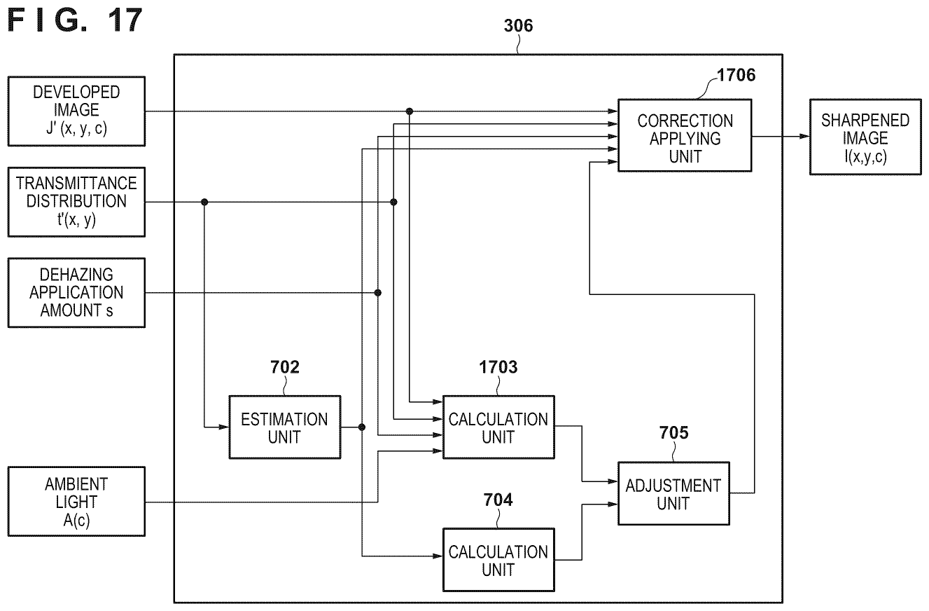

In step S1508, a processing unit 1406 generates a sharpened image I by performing sharpening processing on the developed image J′ using the ambient light A(c) and the shaped transmittance distribution t′. An example of a functional configuration of the processing unit 1406 is illustrated in a block diagram of FIG. 17. In FIG. 17, the functional units that are the same as the functional units that are illustrated in FIG. 7 are assigned the same reference numerals, and description pertaining to those functional units will be omitted.

The estimation unit 702 obtains an illumination distribution L using the shaped transmittance distribution t′. A calculation unit 1703 obtains a maximum gain gd by performing computation processing according to Equation 7 using the application amount of dehazing processing that has been received from the computer apparatus 102 instead of the haze density s. The calculation unit 704 identifies a dark portion correction/bright portion correction gain gr that corresponds to the illumination distribution L. The adjustment unit 705 obtains a gain-to-be-applied gr′ using the maximum gain gd, the dark portion correction/bright portion correction gain gr, and the illumination distribution L. A correction applying unit 1706 generates a sharpened image I by performing computation processing according to Equation 10 using the application amount of dehazing processing that has been received from the computer apparatus 102 instead of the haze density s.

As described above, according to the present embodiment, it is possible to not only achieve the advantageous effects according to the first embodiment but also adjust the application amount of dehazing processing according to a user operation and generate a sharpened image that accords with that user operation.

### Third Embodiment

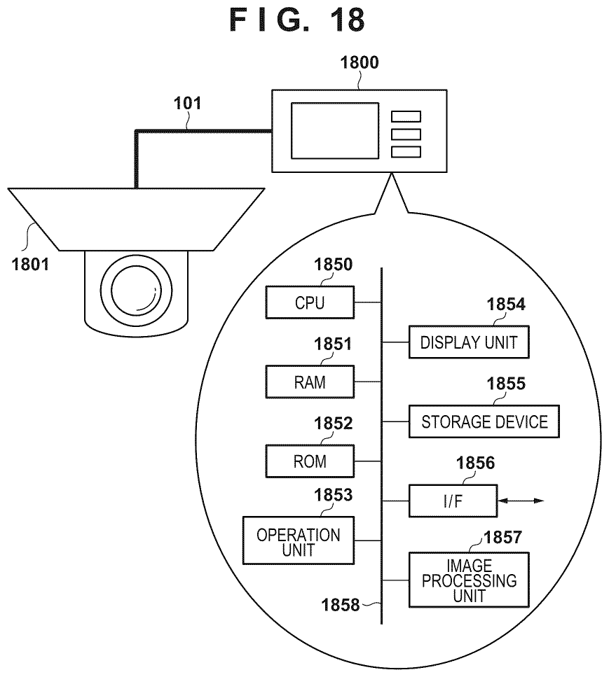

First, an example of a configuration of a system according to the present embodiment will be described with reference to FIG. 18. As illustrated in FIG. 18, the system according to the present embodiment includes a camera 1801 and a computer apparatus 1800, which serves as an image processing apparatus. The camera 1801 and the computer apparatus 1800 are configured to be able to perform data communication therebetween via the video transmission cable 101.

The camera 1801 is an example of an image capturing apparatus that captures a moving image or still images. When capturing a moving image, the camera 1801 outputs, as captured images, images of respective frames in the moving image. When capturing still images, the camera 1801 outputs, as captured images, still images that have been captured at regular or irregular intervals. The captured images that have been outputted from the camera 1801 are inputted to the computer apparatus 1800 via the video transmission cable 101.

The computer apparatus 1800 generates output images by performing various kinds of image processing, which includes the above-described sharpening processing, on the captured images that have been outputted from the camera 1801 and outputs the generated output images.

A CPU 1850 executes various kinds of processing using computer programs and data that are stored in a RAM 1851 and a ROM 1852. The CPU 1850 thus controls the operation of the entire the computer apparatus 1800 and executes or controls various kinds of processing, which will be described as processes to be performed by the computer apparatus 1800.

The RAM 1851 includes an area for storing computer programs and data that have been loaded from the ROM 1852 or a storage device 1855 and an area for storing various kinds of data, which includes captured images that have been received from the camera 1801 via an I/F 1856. The RAM 1851 further includes a work area that the CPU 1850 and an image processing unit 1857 use when executing various kinds of processing. The RAM 1851 can thus provide various kinds of areas as appropriate.

The ROM 1852 stores setting data of the computer apparatus 1800, computer programs and data that are related to the startup of the computer apparatus 1800, computer programs and data related to basic operations of the computer apparatus 1800, and the like.

An operation unit 1853 is a user interface, such as a keyboard, a mouse, and a touch panel, and by operating it, the user can input various kinds of instructions to the CPU 1850.

A display unit 1854 includes a liquid crystal screen or a touch panel screen and can displays results of processing by the CPU 1850 and the image processing unit 1857, using images, text, and the like. The display unit 1854 may be a projection device, such as a projector for projecting images and text.

The storage device 1855 is a mass information storage device that is a non-volatile memory. The storage device 1855 stores an operating system (OS); computer programs and data for causing the CPU 1850 or the image processing unit 1857 to execute or control various kinds of processing, which will be described as processes to be performed by the computer apparatus 1800; and the like. The computer programs and data that are stored in the storage device 1855 are loaded into the RAM 1851 as appropriate according to control by the CPU 1850 and are set to be processed by the CPU 1850 and the image processing unit 1857. The I/F 1856 is a communication interface for performing data communication with the camera 1801 via the aforementioned video transmission cable 101.

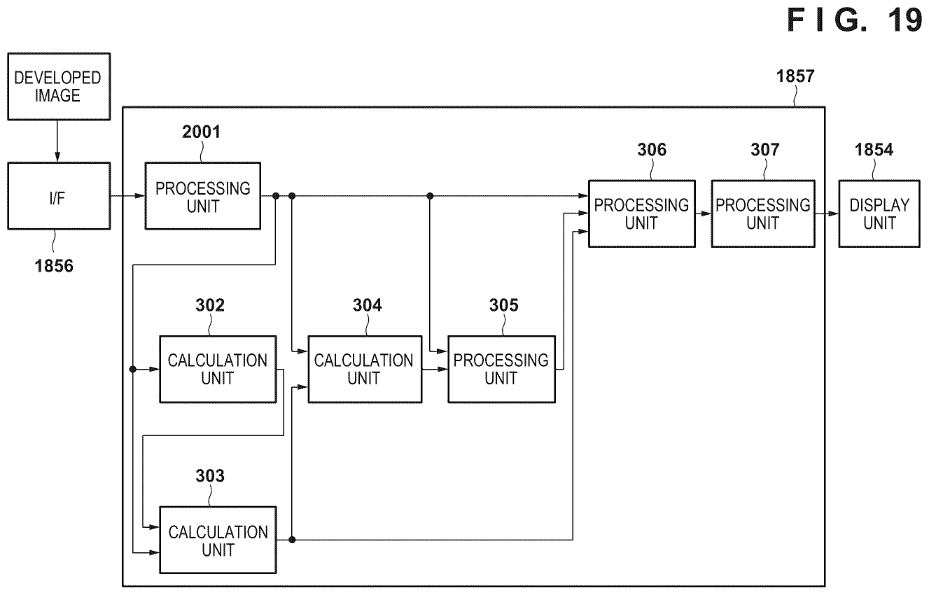

The image processing unit 1857 generates output images by performing various kinds of processing, which includes the above-described sharpening processing, on the captured images that have been received from the camera 1801. An example of a functional configuration of the image processing unit 1857 is illustrated in a block diagram of FIG. 19. In FIG. 19, the functional units that are the same as the functional units that are illustrated in FIG. 3 are assigned the same reference numerals, and description pertaining to those functional units will be omitted.

All of the functional units that are illustrated in FIG. 19 will be described below as being implemented by hardware. However, one or more of the functional units that are illustrated in FIG. 19 may be implemented by software (computer programs), and in such cases, the functions of the one or more functional units are realized by the CPU 1850 executing the computer programs that correspond to the one or more functional units.

The CPU 1850, the RAM 1851, the ROM 1852, the operation unit 1853, the display unit 1854, the storage device 1855, the I/F 1856, and the image processing unit 1857 are all connected to a system bus 1858.

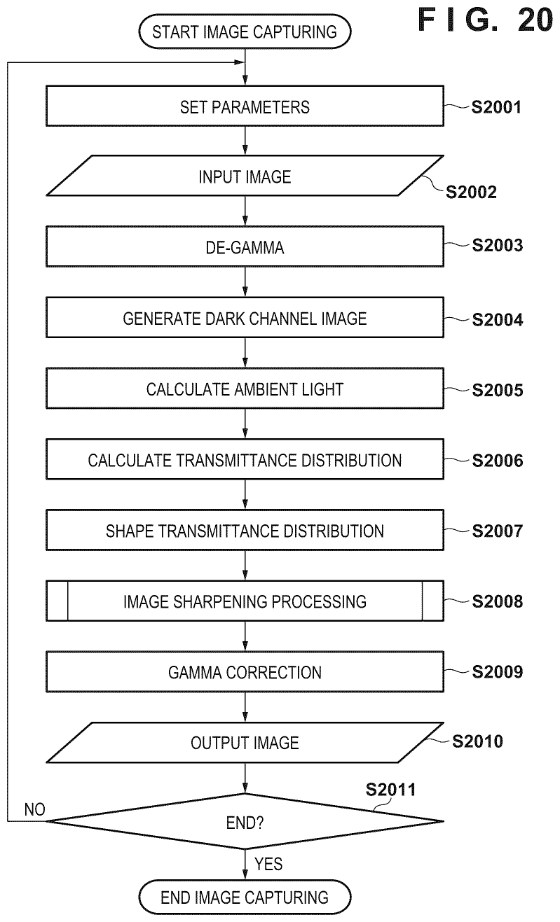

A process to be performed by the computer apparatus 1800 to generate a sharpened image based on a captured image (developed image (input image) that has been generated by the camera 1801 performing development processing on a RAW image) that has been received from the camera 1801 will be described with reference to a flowchart of FIG. 20.

In step S2001, the CPU 1850 loads into the RAM 1851 and sets “various parameters to be used in the subsequent processes”, which are stored in the ROM 1852 or the storage device 1855.

In step S2002, the CPU 1850 receives a developed image J′ that been transmitted from the camera 1801 via the I/F 1856, and stores the received developed image J′ in the RAM 1851 or the storage device 1855.

In step S2003, a processing unit 2001 performs de-gamma processing, which is a process for linearizing the developed image J′, on the developed image J′ that has been received in step S2002. The following developed image J′ is a de-gamma image for which de-gamma processing has been performed on the developed image J′ that has been received in step S2002.

In step S2004, the calculation unit 302 generates a dark channel image from the developed image J′, similarly to the first embodiment. In step S2005, the calculation unit 303 calculates (estimates) an ambient light A(c) of the color channel c using the dark channel image that has been generated in step S2004, similarly to the first embodiment.

In step S2006, the calculation unit 304 calculates an atmospheric transmittance distribution t using the developed image J′ and the ambient light A(c), similarly to the first embodiment. In step S2007, the processing unit 305 generates a shaped transmittance distribution t′ by performing shaping processing on the transmittance distribution t using the developed image J′, similarly to the first embodiment.

In step S2008, the processing unit 306 generates a sharpened image I by performing sharpening processing on the developed image J′ using the ambient light A(c) and the shaped transmittance distribution t′, similarly to the first embodiment.

In step S2009, the processing unit 307 generates an output image (gamma-corrected sharpened image) I′ by performing gamma correction on the sharpened image I, which has been generated in step S2008, similarly to the first embodiment.

In step S2010, the processing unit 307 displays the output image I′, which has been generated in step S2009, on the display unit 1854. The output destination of the output image is not limited to the display unit 1854.

In step S2011, the CPU 1850 determines whether a condition for ending the process has been satisfied. If the result of such determination is that the condition for ending the process has been satisfied, the process according to the flowchart of FIG. 20 ends, and if the condition for ending the process has not been satisfied, the process proceeds to step S2001.

### Fourth Embodiment

In the first and second embodiments, the camera 100 and the computer apparatus 102 are separate apparatuses. However, the camera 100 and the computer apparatus 102 may be integrated to form a single image processing apparatus that includes the functions of the camera 100 and the functions of the computer apparatus 102. It is similar for the third embodiment, and the camera 1801 and the computer apparatus 1800 may be integrated to form a single image processing apparatus that includes the functions of the camera 1801 and the functions of the computer apparatus 1800. Further, one apparatus may be implemented by a plurality of apparatuses, and the processes that have been described to be performed by a single apparatus may be performed with distributed processing by the plurality of apparatus.

In the first and the second embodiments, the output destination of the sharpened image I is the display 103; however, the output destination of the sharpened image I is not limited to the display 103. For example, the sharpened image I may be transmitted to an external apparatus via a network line, such as a LAN or the Internet, or may be stored in a memory in the computer apparatus 102 or another apparatus.

In the first and the second embodiments, the image processing unit 208 obtains, as a target of (input image for) sharpening processing, a developed image that has been obtained by performing developing processing on a RAW image that has been outputted from the image capturing sensor 212. However, the method of obtaining an input image is not limited to a specific method of obtainment. For example, the image processing unit 208 may obtain, as an input image, an image that is stored in the storage medium 204 or an image that has been received from an external apparatus, such as the computer apparatus 102, via the communication I/F 205. It is similar for the third embodiment, and the method of obtaining an input image is not limited to a particular method of obtainment.

The numerical values; the processing timings; the processing order; the processing agents; the storage location, source, destination, and method of obtaining data (information); and the like that have been used in the above-described embodiments have been given as examples for the sake of concrete explanation and are not intended to be limited to such examples.

Further, some or all of the above-described embodiments may be used in combination as appropriate. Further, some or all of the above-described embodiments may be used selectively.

### OTHER EMBODIMENTS

Some embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-008181, which was filed on Jan. 23, 2023 and which is hereby incorporated by reference herein in its entirety.

What is claimed is:

1. An image processing apparatus comprising:
one or more memories; and
one or more processors, wherein the one or more memories and the one or more processors are configured to:
calculate an atmospheric transmittance distribution based on an input image; and
sharpen the input image based on an illumination distribution that has been calculated based on the transmittance distribution.

2. The image processing apparatus according to claim 1, wherein the one or more memories and the one or more processors are further configured to:
generate, based on the input image, a dark channel image whose pixel values are minimum color channel values of respective local regions in the input image;
calculate ambient light based on the dark channel image; and
calculate the transmittance distribution based on the input image and the ambient light.

3. The image processing apparatus according to claim 2, wherein the one or more memories and the one or more processors are further configured to:
calculate a first gain based on the input image, the ambient light, an application amount of dehazing processing, and the transmittance distribution,
obtain a second gain based on the illumination distribution, and
sharpen the input image based on a third gain which has been obtained based on the first gain, the second gain, and the illumination distribution; on the input image; on the transmittance distribution; on the application amount; and on the ambient light.

4. The image processing apparatus according to claim 3, wherein the one or more memories and the one or more processors are further configured to:
use, as the application amount, a haze density that has been obtained based on a luminance value of the input image.

5. The image processing apparatus according to claim 3, wherein the one or more memories and the one or more processors are further configured to:
use, as the application amount, a value that has been set according to a user operation.

6. The image processing apparatus according to claim 1, wherein the one or more memories and the one or more processors are further configured to:
perform gamma correction on the sharpened input image.

7. The image processing apparatus according to claim 1, further comprising:
an image capturing unit,
wherein the one or more memories and the one or more processors are further configured to generate the input image by performing development processing on a RAW image that is obtained by image capturing by the image capturing unit.

8. The image processing apparatus according to claim 1, wherein the one or more memories and the one or more processors are further configured to:
obtain, as the input image, an image captured by an image capturing apparatus.

9. An image processing method performed by an image processing apparatus, the method comprising:
calculating an atmospheric transmittance distribution based on an input image; and
sharpening the input image based on an illumination distribution that has been calculated based on the transmittance distribution.

10. A non-transitory computer-readable storage medium storing a computer program for causing a computer to:
calculate an atmospheric transmittance distribution based on an input image; and
sharpen the input image based on an illumination distribution that has been calculated based on the transmittance distribution.
